(19) United States
(12) Patent Application Publication
(10) Pub. No.: US 2009/0240901 A1
(43) Pub. Date: Sep. 24, 2009

(54) INFORMATION PROCESSING APPARATUS, STORAGE CONTROL DEVICE AND CONTROL METHOD

(75) Inventor: Shu NAKAMURA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/408,714

(22) Filed: Mar. 22, 2009

(30) Foreign Application Priority Data
Mar. 21, 2008 (JP) 2008-072757

(51) Int. Cl. G06F 12/00

(52) U.S. Cl. 711/155; 711/E12.001

(57) ABSTRACT

A computer, which includes multiple memory modules each of which is provided with an SPD for storing setting information about the memory, a setting information acquisition section of an SPD controller of a memory controller, obtains setting information from the SPD of each memory module, and the setting information is held in a setting information holding section. The storage control device of the computer compares the acquired pieces of setting information. When the contents of the pieces of setting information are different from one another, the storage control device overwrites setting information in the SPD's of the memory modules other than the memory module corresponding to the setting information by using the contents of any one of the pieces of setting information.

### CROSS-REFERENCE TO RELATED APPLICATIONS

This application claims priority from Japanese patent application Serial no. 2008-072757 filed Mar. 21, 2008, the contents of which are incorporated by reference herein.

### BACKGROUND OF THE INVENTION

1. Field of the Invention

The present invention relates to an information processing apparatus which performs storage control in the case where multiple storage modules are provided each of which has a storage circuit and a setting information holding circuit for holding setting information about the storage circuit.

More particularly, the present invention relates to a storage control device and control method for controlling the storage modules using the setting information.

2. Description of the Related Art

Generally, a memory module provided for an information processing apparatus (hereinafter referred to as a “computer”) is mounted with a setting information holding circuit which is called an SPD (Serial Presence Detect). In the SPD, there is stored setting information or configuration information which is to be used for determining the contents of the processing operation of a memory controller and which is information about the specifications of the memory module, such as the memory size of an each RAM chip and the like, maximum operating frequency and signal timing.

The computer obtains the setting information stored in the SPD of the mounted memory module to determine the contents of memory control.

Now, description will be made on an example of conventional memory control on the system board of a computer provided with multiple memory modules, with the use of FIGS. 8 and 9.

As shown in FIG. 8, in the system board of a computer 9, there are mounted multiple memory modules 91 (91A and 91B) and a memory controller 95 together with one or multiple CPU's 90.

Furthermore, on the memory modules 91 (91A and 91B), there are mounted memories 92 (92A and 92B) and SPD's 93 (93A and 93B).

In the SPD's 93 (93A and 93B), there is stored information about the specifications of the memory modules 91 (91A and 91B), for example, setting information such as memory size, maximum operating frequency and signal timing so that the CPU's 90 can normally access the memories. In the configuration example shown in FIG. 8, setting information SPD_A and setting information SPD_B are stored in the SPD 93A of the memory module 91A and the SPD 93B of the memory module 91B, respectively.

In the memory controller 95, there are mounted with an SPD control section 96 which performs reading/writing of the pieces of setting information SPD_A and SPD_B from the SPD's 93A and 93B of the memory modules 91A and 91B, respectively.

The memory controller 95 is connected to one or multiple CPU's 90, and it controls the memory modules on the basis of the pieces of setting information SPD_A and SPD_B read by the SPD control section 96.

As methods for notifying the computer of the functions and specifications of the memory modules 91 (91A and 91B), Japanese Patent Laid-Open No. 2004-78934 discloses conventional methods as shown below.

In a first conventional method, the pieces of setting information SPD_A and SPD_B stored in the SPD's 93 (93A and 93B) are used as they are. In the computer 9, the SPD control section 96 reads the pieces of setting information SPD_A and SPD_B from the SPD's 93 (93A and 93B) of the memory modules 91 (91A and 91B), respectively, at the boot time. The memory controller 95 sets the contents of memory control so that the reliability of access can be assured, on the basis of the read pieces of setting information (memory size, maximum operating frequency, signal timing and the like) (step S90 in FIG. 9).

In a second conventional method, the memory controller 95 makes adjustment in order to cause the memory modules 91 (91A and 91B) to operate at a higher or lower operating frequency relative to the operating frequency of the FSB (front side bus) of the CPU 90, on the basis of the pieces of setting information SPD_A and SPD_B read from the SPD's 93 (93A and 93B), and it notifies a concrete adjusted value to the system control section of the computer 9 (step S91 in FIG. 9).

However, in the conventional methods, when multiple memory modules are mounted in a computer, and the pieces of setting information in the SPD's of the memory modules are different from one another, it is necessary to cause the pieces of setting information in the SPD's of the memory modules to agree with one another.

Therefore, when the memory operating frequencies in the SPD's of the multiple memory modules mounted on the system board are different from one another, it is necessary to provide an adjustment circuit or the like for setting a ratio for causing the values of the memory operating frequencies to be the same, for each memory module.

Furthermore, there is a problem that a memory module with a memory operating frequency higher than the FSB operating frequency of a CPU cannot be used by the CPU.

### SUMMARY OF THE INVENTION

The object of the present invention is to provide an information processing apparatus capable of, for multiple memory modules having different pieces of setting information in their SPD's, causing the contents of the pieces of setting information to agree with one another, without providing an adjustment circuit for setting a ratio of memory operating frequency for each of the mounted memory modules, a storage control device, and a control method.

The information processing apparatus according to the present invention comprises: a first storage module having a first storage circuit and a first setting information holding circuit for holding a first piece of setting information about the first storage circuit; a second storage module having a second storage circuit and a second setting information holding circuit for holding a second piece of setting information about the second storage circuit; and a storage control device connected to the first and second storage modules, which obtains the first and second pieces of setting information and which, when the first and second pieces of setting information are different from each other, overwrites the other piece of setting information by using the contents of any one of the first and second pieces of setting information.

When multiple memory modules are provided, a memory controller provided for this computer obtains setting information from the setting information holding circuit (SPD) of each memory module. When the contents of the pieces of setting information are different from one another, the memory controller uses the contents of one of the obtained pieces of setting information to overwrite the pieces of setting information in the SPD's of the other memory modules. Thus, it is possible to uniform the pieces of setting information about the multiple memory modules mounted on the computer.

Furthermore, when the pieces of setting information about the first and second storage modules are different from each other, the memory controller overwrites the other pieces of setting information by using the contents of one of the held pieces of setting information. It is, thereby, possible to uniform the pieces of setting information about the multiple memory modules mounted on the computer.

Furthermore, this setting information may include operating frequency information about the storage module. When first and second pieces of operating frequency information included in the first and second pieces of setting information are different from each other, the memory controller uses lower operating frequency information between the first and second pieces of operating frequency information to overwrite the operating frequency information included in the other piece of setting information.

The control method according to the present invention is a control method for an information processing apparatus including a first storage module having a first storage circuit and a first setting information holding circuit for holding a first piece of setting information about the first storage circuit, a second storage module having a second storage circuit and a second setting information holding circuit for holding a second piece of setting information about the second storage circuit, and a storage control device connected to the first and second storage modules, the method comprises: a step of the storage control device acquiring the first and second pieces of setting information from the first and second storage modules; and a step of, when the first and second pieces of setting information are different from each other, using the contents of any one of the first and second pieces of setting information to overwrite the other piece of setting information.

When multiple memory modules are mounted on the system board of a computer, and pieces of setting information stored in the SPD's in the memory modules are different from one another, it is possible to, by using the contents of one of the pieces of setting information read from the memory modules to overwrite the pieces of setting information in the SPD's of the other memory modules, cause the pieces of setting information about the multiple memory modules to agree with one another.

Therefore, the necessity of providing an adjustment circuit for setting a rate for causing the memory operating frequency to be constant for each memory module is eliminated.

Especially, for such multiple memory modules that the memory operating frequencies in their pieces of setting information are different from one another, it is possible to cause the memory operating frequencies of the other memory modules to agree with a lower memory operating frequency of one memory module.

Furthermore, when there is such a memory module that the memory operating frequency in its setting information is higher than the FSB operating frequency of the CPU, the setting information about this memory module is rewritten with the value of a lower memory operating frequency adjusted to be the FSB operating frequency of the CPU. Thereby, it is possible to use a memory module which the CPU conventionally could not use and enlarge the data holding area of the CPU.

### BRIEF DESCRIPTION OF THE DRAWINGS

FIG. 1 is a diagram showing an example of the configuration in the system board of an information processing apparatus (computer) according to an embodiment of the present invention.

FIG. 2 is a diagram for illustrating the processing by a storage control device (memory controller) at the boot time according to an embodiment of the present invention.

FIG. 3 is a diagram for illustrating the processing by the storage control device (memory controller) at the reboot time according to an embodiment of the present invention.

FIG. 4 is a diagram showing an example of changing values in setting information stored in a setting information holding circuit (SPD) according to an embodiment of the present invention.

FIG. 5 is a processing flow diagram of the storage control device (memory controller) at the boot time according to an embodiment of the present invention.

FIGS. 6 and 7 are processing flow diagrams of the storage control device (memory controller) in the case of occurrence of degeneracy of a memory module according to an embodiment of the present invention.

FIG. 8 is a diagram for illustrating an example of conventional memory control in the system board of an information processing apparatus (computer) provided with multiple memory modules.

FIG. 9 is a processing flow diagram of the conventional memory control.

### DETAILED DESCRIPTION OF THE PREFERRED EMBODIMENTS

A preferred embodiment of the present invention will be described below.

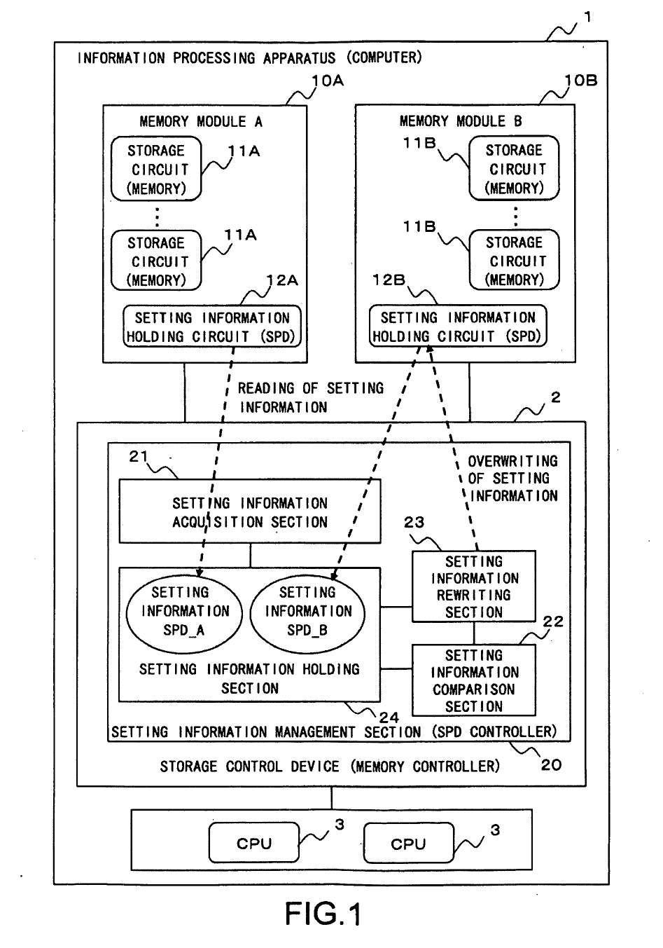

FIG. 1 is a diagram showing an example of the configuration in the system board of an information processing apparatus (computer) 1 according to an embodiment of the present invention.

On the system board of the computer 1, there are mounted multiple memory modules 10 (10A and 10B), a memory controller 2, and one or multiple CPU's 3. The multiple CPU's 3 are connected to the memory controller 2.

Each of the memory modules 10 (10A and 10B) is mounted with one or multiple memories 11 (11A and 11B), each of which is configured by a RAM chip or the like, and setting information holding circuits (SPD's) 12 (12A and 12B).

The SPD 12 is embodied by an electrically erasable ROM for reading and writing data in a serial method (a serial EEPROM). The SPD itself is in conformity with the standard of “JESD21: Configuration for Solid State Memories” formulated by JEDEC (Joint Electron Device Engineering Council). Setting information in which definitions about the specifications of a memory module, such as memory size, maximum clock frequency and signal timing are set, is stored in the SPD 12 in accordance with this standard.

In the SPD 12A, setting information SPD_A showing the specifications of the memory 11A mounted on the memory module 10A is stored. Similarly, setting information SPD_B about the memory module 10B is stored in the SPD 12B.

The memory controller 2 is provided with an SPD controller 20.

In the initialization processing performed when the computer 1 is booted/rebooted up, the SPD controller 20 reads the pieces of setting information SPD_A and SPD_B stored in the SPD 12A and 12B of the memory modules 10A and 10B, and performs processing for writing predetermined information into the SPD 12A and 12B using the contents of the read pieces of setting information.

The SPD controller 20 has a setting information acquisition section 21, a setting information comparison section 22, a setting information rewriting section 23, and a setting information holding section 24.

The setting information acquisition section 21 reads the pieces of setting information SPD_A and SPD_B from the SPD's 12A and 12B of all the memory modules 10A and 10B mounted on the system board and stores them into the setting information holding section 24.

The setting information comparison section 22 compares the pieces of setting information stored in the setting information holding section 24. If the pieces of setting information SPD_A and SPD_B about the memory modules 10A and 10B are different from each other, one is selected between the pieces of setting information.

The setting information rewriting section 23 overwrites the pieces of setting information in the SPD's 12A and 12B of the memory modules 10A and 10B using the contents of the one piece of setting information selected by the setting information comparison section 22.

The setting information holding section 24 stores all or a part of the pieces of setting information SPD_A and SPD_B in the SPD's 12A and 12B read by the setting information acquisition section 21.

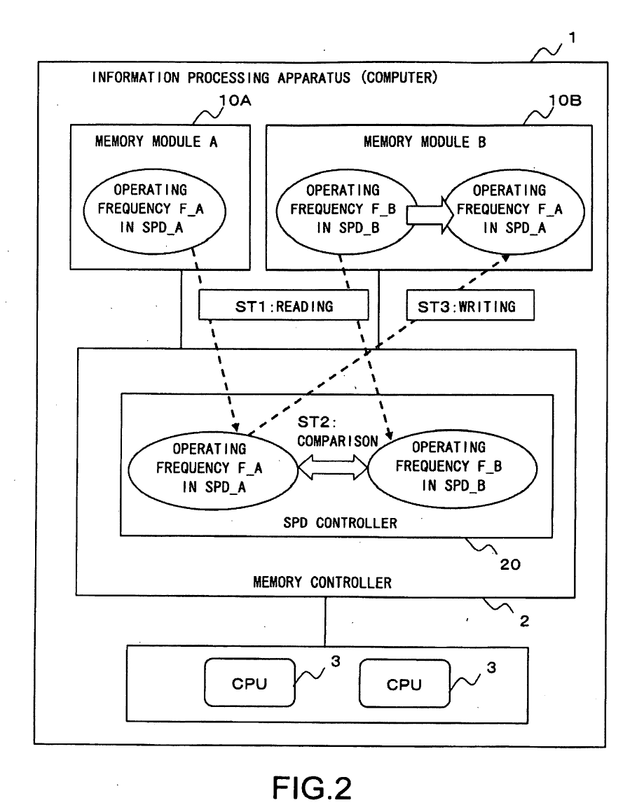

The processing performed by the memory controller 2 at the boot time will be described with the use of FIG. 2.

The memory controller 2 of the computer 1 shown in FIG. 2 performs the processing of the following steps ST1 to ST3 in the initialization processing at the boot time so as to cause the memory operating frequencies in the pieces of setting information stored in the SPD 12A and 12B of the multiple memory modules 10A and 10B mounted on the system board to agree with a lower value.

Step ST1: Reading

The setting information acquisition section 21 of the SPD controller 20 reads each of the setting information SPD_A stored in the SPD 12A of the memory module 10A and the setting information SPD_B stored in the SPD 12B of the memory module 10B. The setting information acquisition section 21 stores it into the setting information holding section 24.

Here, it is assumed that the values of the memory operating frequencies in the setting information SPD_A and the setting information SPD_B are different from each other, and a memory operating frequency F_A in the setting information SPD_A shows a value lower (slower) than that of a memory operating frequency F_B in the setting information SPD_B.

Step ST2: Comparison

The setting information comparison section 22 of the SPD controller 20 compares the setting information SPD_A and the setting information SPD_B stored in the setting information holding section 24. The setting information comparison section 22 detects that the memory operating frequency is different between the setting information SPD_A and the setting information SPD_B. Then, in order to adjust the memory operating frequencies of all the memory modules 10 to be the lower memory operating frequency in the setting information SPD_A, The setting information comparison section 22 identifies, as a value used for rewriting processing, the memory operating frequency F_A in the setting information SPD_A.

Step ST3: Writing

The setting information rewriting section 23 of the SPD controller 20 overwrites the memory operating frequency F_B (value) in the setting information SPD_B in the SPD 12B of the memory module 10B with the identified value of the memory operating frequency F_A.

Furthermore, after the processing of steps ST1 to ST3, the setting information acquisition section 21 reads the setting information SPD_A and the setting information SPD_B from the SPD's 12A and 12B, respectively (step ST1). Then, the setting information comparison section 22 compares the setting information SPD_A and the setting information SPD_B (step ST2). It is confirmed that the memory operating frequency in the setting information SPD_A and that in the setting information SPD_B are the same, and that all the memory modules 10 (10A and 10B) mounted on the system board have the same setting information.

In this way, the pieces of setting information about all the memory modules 10 (10A and 10B) mounted on the system board can be adjusted to agree with the setting information about the memory module 10A with a low (slow) memory operating frequency, and therefore, the CPU's 3 can use these memory modules 10A and 10B.

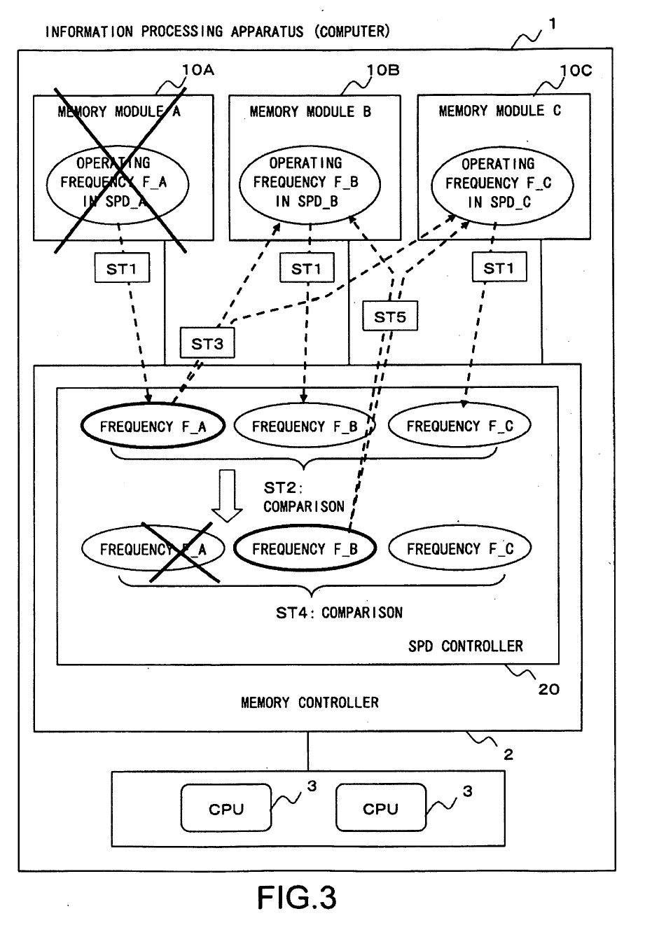

Next, the processing by the memory controller 2 at the reboot time will be described with the use of FIG. 3.

On the system board of the computer 1 shown in FIG. 3, there are mounted multiple memory modules 10 (10A, 10B and 10C), a memory controller 2 and one or multiple CPU's 3.

It is assumed that the contents of pieces of setting information SPD_A, SPD_B and SPD_C stored in the SPD's 12A, 12B and 12C of the memory modules 10A, 10B and 10C, respectively, are different from one another, and that the values of the memory operating frequencies F_A, F_B and F_C are in the relation of “F_A<F_B<F_C”.

It is also assumed that the memory module 10A with a lower (slower) operating frequency breaks down and degenerates due to some cause during operation.

First, in the initialization processing performed when the computer 1 is booted up, the memory controller 2 performs the processing of the following steps ST1 to ST3 in order to overwrite the pieces of setting information stored in the SPD's 12 of the memory modules 10 with any one piece of setting information.

Step ST1: Reading

The setting information acquisition section 21 of the SPD controller 20 reads each of the setting information SPD_A stored in the SPD 12A of the memory module 10A, the setting information SPD_B stored in the SPD 12B of the memory module 10B, and the setting information SPD_C stored in the SPD 12C of the memory module 10C. The setting information acquisition section 21 stores it into the setting information holding section 24.

Step ST2: Comparison

The setting information comparison section 22 of the SPD controller 20 compares the pieces of setting information SPD_A, SPD_B and SPD_C stored in the setting information holding section 24. The setting information comparison section 22 detects that the values of the memory operating frequencies in the pieces of setting information are different from one another.

Therefore, the setting information comparison section 22 identifies the memory operating frequency F_A in the setting information SPD_A, which is slower among the memory operating frequencies of all the memory modules 10, as a value used for rewriting processing.

Step ST3: Writing

The setting information rewriting section 23 of the SPD controller 20 writes over the value of the memory operating frequency F_B in the setting information SPD_B in the SPD 12B of the memory module 10B with the identified value of the memory operating frequency F_A in the setting information SPD_A. Similarly, the setting information rewriting section 23 writes over the value of the memory operating frequency F_C in the setting information SPD_C in the SPD 12C of the memory module 10C with the value of the memory operating frequency F_A.

Through the processing of steps ST1 to ST3, the memory operating frequency F_A is written in the SPD's 12 (12A, 12B and 12C) of all the memory modules 10 (10A, 10B and 10C).

After that, when the memory module 10A degenerates, the memory controller 2 performs the processing of the following steps ST4 and ST5 in the initialization processing at the reboot time.

Step ST4: Comparison

The setting information comparison section 22 compares the value of the memory operating frequency F_A in the setting information SPD_A of the degenerated memory module 10A and the values of the memory operating frequencies F_B and F_C in the pieces of setting information SPD_B and SPD_C of the other memory modules 10B and 10C, on the basis of the setting information stored in the setting information holding section 24. It is assumed that the setting information comparison section 22 determines that the value of the operating frequency F_A is lower than the values of the memory operating frequencies F_B and F_C.

Next, the setting information comparison section 22 compares the values of the memory operating frequencies F_B and F_C, and identifies the memory operating frequency F_B, which is lower, as information (value) used for rewriting processing.

Step ST5: Writing

The setting information rewriting section 23 of the SPD controller 20 overwrites the memory operating frequency F_C (value) in the setting information SPD_C stored in the SPD 12C of the memory module 10C with the identified value of the memory operating frequency F_B.

Thereby, it is possible to, after degeneracy of the memory module 10A, change the memory operating frequencies of the usable memory modules 10B and 10C on the system board to the memory operating frequency F_B which is faster than the memory operating frequency F_A of the setting information SPD_A. Consequently, the CPU's 3 can use the usable memory modules at a faster operation speed.

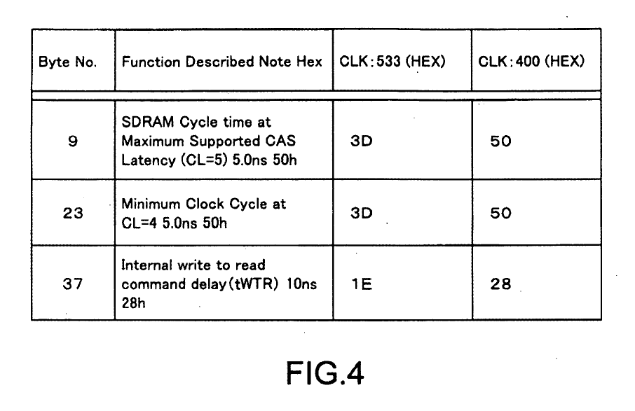

FIG. 4 shows an example of the data configuration of a part of the setting information stored in the SPD's 12.

The example of the data configuration of the setting information shown in FIG. 4 is an example of items related to the memory operating frequency in setting information based on the standard of “JESD21: Configuration for Solid State Memories”.

It is assumed that, in the computer 1 with the configuration shown in FIG. 2, the memory operating frequency F_B in the setting information about the memory module 10B is 533 M (the number of clocks), and the memory operating frequency F_A in the setting information about the memory module 10A is 400 M (the number of clocks).

When the memory operating frequency in the setting information about the memory module 10B is rewritten from 533 M to 400 M by the setting information rewriting section 23 of the SPD controller 20, the values (CLK(HEX)) of the item 9 (SDRAM Cycle time at Maximum Supported CAS Latency), the item 23 (Minimum Clock Cycle) and the item 37 (Internal write to read command delay (tWTR)), which are related to the memory operating frequency, in the setting information shown in FIG. 4, are rewritten to “3D_{—}50”, “3D_{—}50” and “1E_{—}28”, respectively.

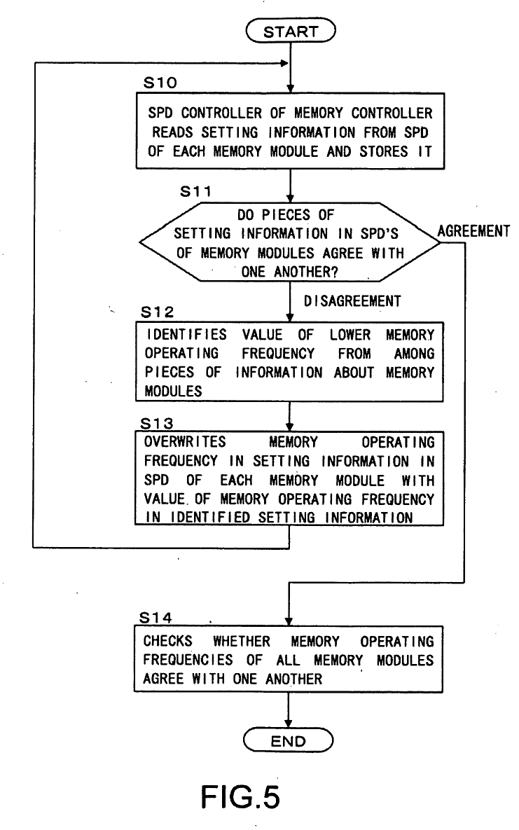

FIGS. 5 to 7 show the processing flow of the memory controller 2.

FIG. 5 is a processing flow diagram of the memory controller 2 at the boot time.

In the SPD controller 20 of the memory controller 2, the setting information acquisition section 21 reads setting information from the SPD's 12 of all the memory modules 10 mounted on the system board. The setting information acquisition section 21 stores the setting information into the setting information holding section 24 (step S10).

Next, the setting information comparison section 22 compares the pieces of setting information about all the memory modules 10 to check whether they are the same (step S11). If the values of the memory operating frequencies in the collected pieces of setting information are different (“disagreement” of step S11) as a result of the comparison, then the flow proceeds to processing of step S12. If the values of the memory operating frequencies in the pieces of setting information are the same (“agreement” of step S11), then the flow proceeds to processing of step S14.

In the processing of step S12, the setting information comparison section 22 identifies a piece of setting information in which the memory operating frequency is low (slow) from among the pieces of setting information in the setting information holding section 24. Then, the setting information rewriting section 23 overwrites the memory operating frequency in the setting information in each of the SPD's 12 of all the memory modules 10, with the value of the memory operating frequency in the piece of setting information identified by the processing of step S12 (step S13).

In the processing of step S14, the setting information comparison section 22 checks whether the memory operating frequencies in the pieces of setting information stored in the SPD's 12 of all the memory modules 10 agree with one another.

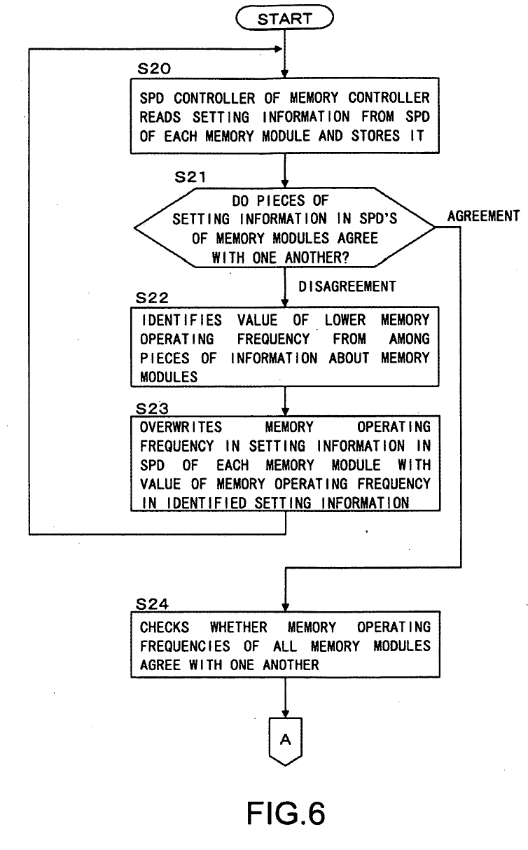

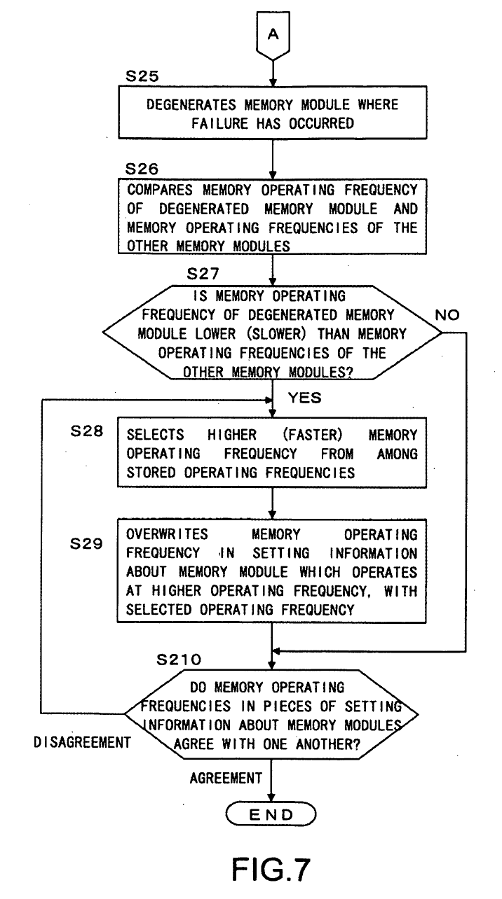

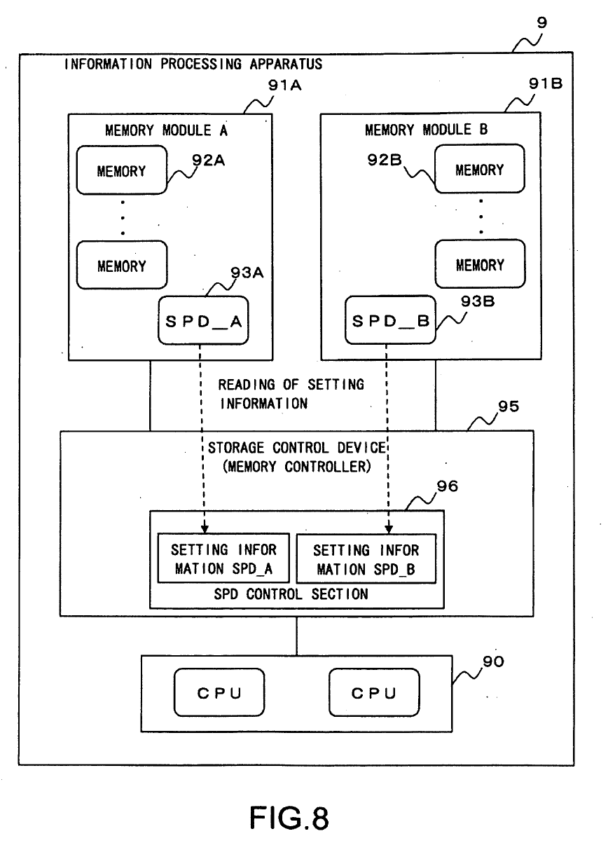

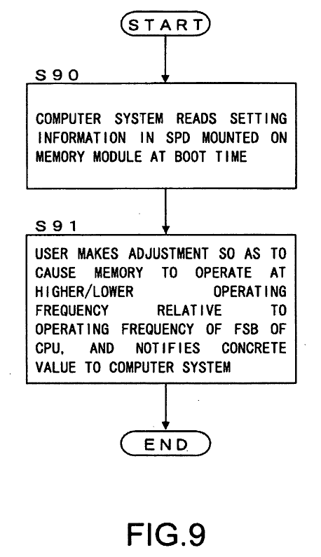

FIGS. 6 and 7 are a processing flow diagrams of the memory controller 2 in the case of occurrence of degeneracy of a memory module.

Since the contents of the processing of steps S20 to S24 in the processing flow shown in FIG. 6 are similar to the contents of the processing of steps S10 to S14 in the processing flow of FIG. 5, description thereof will be omitted.

When the memory module 10A on the system board degenerates (step S25), the setting information comparison section 22 compares the memory operating frequency F_A in the setting information about the degenerated memory module 10A stored in the setting information holding section 24 with the memory operating frequencies F_B and F_C in the pieces of setting information about the other memory modules 10B and 10C stored in the setting information holding section 24 (step S26).

If the value the memory operating frequency F_A shows a value lower (slower) than the memory operating frequencies F_B and F_C (step S27: YES), then the setting information comparison section 22 selects the memory operating frequency F_B, which is higher (faster), from among the memory operating frequencies stored in the setting information holding section 24 (step S28). Then, since the memory operating frequency F_C of the memory module 10C is higher than the memory operating frequency F_B, the setting information rewriting section 23 overwrites the memory operating frequency F_C in the SPD 12C of the memory module 10C with the memory operating frequency F_B (step S29).

After that, the setting information comparison section 22 checks whether the memory operating frequencies in the pieces of setting information stored in the SPD's 12 of all the memory modules 10 agree with one another (step S210).

As described above, the memory controller 2 of the computer 1 can change pieces of setting information stored in the SPD's of memory modules mounted on the system board by directly rewriting the pieces of setting information. Therefore, even if multiple memory modules are implemented on the system board, it is possible to uniform the pieces of setting information in the SPD's.

Especially, when the memory operating frequencies in the pieces of setting information in the SPD's of the memory modules are different from one another, the memory operating frequencies of all the memory modules can be adjusted to be the memory operating frequency of a memory module which operates under a lower (slower) value.

Furthermore, the user can cause the memory operating frequencies in the pieces of setting information in the SPD's of all the memory modules to agree with a value set by the user, for example, the value of the operating frequency of the FSB of the CPU.

The present invention has been described with an embodiment thereof. It is natural that the present invention can be variously varied within the scope not deviating from the spirit thereof.

For example, in the case where one of the memory modules mounted on the system board of the computer 1 breaks down and degenerates during operation, if the memory operating frequency in the setting information in the SPD of the degenerated memory module is lower (slower) than the memory operating frequencies of the other memory modules, the setting information rewriting section 23 may overwrite the information changed by the setting information rewriting processing performed at the boot time, back to the values of the original setting information in the SPD's of the memory modules (for example, a value of a faster memory operating frequency), using the original setting information stored in the setting information holding section 24.

What is claimed is:

1. An information processing apparatus comprising:
a first storage module having a first storage circuit and a first setting information holding circuit for holding a first piece of setting information about the first storage circuit;
a second storage module having a second storage circuit and a second setting information holding circuit for holding a second piece of setting information about the second storage circuit; and
a storage control device, which is connected to the first and second storage modules, obtains the first and second pieces of setting information and, when the first and second pieces of setting information are different from each other, overwrites the other piece of setting information by using the contents of any one of the first and second pieces of setting information.

2. The information processing apparatus according to claim 1, wherein, when the first and second pieces of setting information are different from each other, the storage control device uses the contents of one of the held pieces of setting information to overwrite the other piece of setting information.

3. The information processing apparatus according to claim 1, wherein
the setting information includes operating frequency information about the storage modules; and
when first and second pieces of operating frequency information included in the first and second pieces of setting information are different from each other, the storage control device uses lower operating frequency information between the first and second pieces of operating frequency information to overwrite the operating frequency information included in the other piece of setting information.

4. The information processing apparatus according to claim 3, wherein
the storage control device further comprises an operating frequency information holding section for holding the first and second pieces of operating frequency information which have not been overwritten yet;
the storage control device detects a failure in the first and second storage circuits, and, when detecting a failure in the first or second storage circuit, degenerates the storage circuit where the failure has been detected; and
when the storage circuit which operates at a lower operating frequency between the pieces of operating frequency information held in the operating frequency information holding section degenerates, the storage control device uses a piece of higher operating frequency information between the pieces of operating frequency information held in the operating frequency information holding section to overwrite operating frequency information included in setting information about the storage circuit which operates at the higher operating frequency.

5. A storage control device connected to a first storage module having a first storage circuit and a first setting information holding circuit for holding a first piece of setting information about the first storage circuit and to a second storage module having a second storage circuit and a second setting information holding circuit for holding a second piece of setting information about the second storage circuit, wherein
the storage control device obtains the first and second pieces of setting information; and
when the first and second pieces of setting information are different from each other, overwrite the other piece of setting information by using the contents of any one of the first and second pieces of setting information.

6. The storage control device according to claim 5, wherein, when the first and second pieces of setting information are different from each other, the storage control device uses the contents of one of the held pieces of setting information to overwrite the other piece of setting information.

7. The storage control device according to claim 5, wherein
the setting information includes operating frequency information about the storage modules; and
when first and second pieces of operating frequency information included in the first and second pieces of setting information are different from each other, the storage control device uses lower operating frequency information between the first and second pieces of operating frequency information to overwrite the operating frequency information included in the other piece of setting information.

8. The storage control device according to claim 7, further comprising an operating frequency information holding section for holding the first and second pieces of operating frequency information which have not been overwritten yet; wherein
the storage control device detects a failure in the first and second storage circuits, and, when detecting a failure in the first or second storage circuit, degenerates the storage circuit where the failure has been detected; and
when the storage circuit which operates at a lower operating frequency between the pieces of operating frequency information held in the operating frequency information holding section degenerates, the storage control device uses a piece of higher operating frequency information between the pieces of operating frequency information held in the operating frequency information holding section to overwrite operating frequency information included in setting information about the storage circuit which operates at the higher operating frequency.

9. A control method for an information processing apparatus comprising a first storage module having a first storage circuit and a first setting information holding circuit for holding a first piece of setting information about the first storage circuit, a second storage module having a second storage circuit and a second setting information holding circuit for holding a second piece of setting information about the second storage circuit, and a storage control device connected to the first and second storage modules, the method comprising:
a step of the storage control device obtaining the first and second pieces of setting information from the first and second storage modules; and
a step of, when the first and second pieces of setting information are different from each other, overwriting the other piece of setting information by using the contents of any one of the first and second pieces of setting information.

10. The control method according to claim 9, wherein the step of overwriting the other piece of setting information is a step of overwriting the other piece of setting information by using the contents of one of the held pieces of setting information.

11. The control method according to claim 9, wherein
the setting information includes operating frequency information about the storage modules; and
when first and second pieces of operating frequency information included in the first and second pieces of setting information are different from each other, the storage control device uses lower operating frequency information between the first and second pieces of operating frequency information to overwrite the operating frequency information included in the other piece of setting information.

12. The control method according to claim 11, further comprising:
a step of the operating frequency information holding section holding the first and second pieces of operating frequency information which have not been overwritten yet;
a step of the storage control device detecting a failure in the first and second storage circuits;
a step of, when detecting a failure in the first or second storage circuit, the storage control device degenerating the storage circuit where the failure has been detected; and
a step of, when the storage circuit which operates at a lower operating frequency between the pieces of operating frequency information held in the operating frequency information holding section degenerates, the storage control device overwriting operating frequency information included in setting information about the storage circuit which operates at a higher operating frequency by using a piece of higher operating frequency information between the pieces of operating frequency information held in the operating frequency information holding section.
